(19) United States
(12) Patent Application Publication
(10) Pub. No.: US 2017/0311590 A1
(43) Pub. Date: Nov. 2, 2017

(54) Camouflage Insect Wipes

(71) Applicant: Michael C. Trew, Hodgenville, KY (US)

(72) Inventor: Michael C. Trew, Hodgenville, KY (US)

(21) Appl. No.: 15/141,521

(22) Filed: Apr. 28, 2016

(51) Int. Cl. A01N 25/34; C09D 5/30

(52) U.S. Cl. CPC A01N 25/34; C09D 5/30

(57) ABSTRACT

Hunter's repellent wipes have camouflage properties to differentiate the hunter or people from the animals. Further, the hunter's repellent wipes have insect repellent properties to keep away all types of insects from the hunter.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to a material for camouflaging people from animals, and in particular, for increasing the visibility of a hunter to other hunters.

### 2. Description of Related Art Including Information Disclosed Under 37 CFR 1.97 and 37 CFR 1.98.

For centuries, hunters have used various means of camouflaging themselves from animals which were being hunted. In addition, the military uses camouflage to make people and machinery less perceivable to an enemy. In general, the primary goal of camouflage is to make the person or object blends into the environment.

The military and other camouflage patterns currently being used use a variety of different colors which generally match the colors found in the environment in which the object or person to be camouflaged is located. These colors are typically various subdued shades of green, brown and black. Many animals only perceive things as various shades of gray.

Another problem with camouflage systems is that most of the systems utilize shades of green, brown and black, which tend to blend into the background when perceived by humans. Therefore, the hunter is not visible to other hunters and is in danger of being shot by other hunters. Some examples are listed below with reference to pertinent documents.

U.S. Pat. App. No. 20040200751 A1 from Jack Coonan, teaches a field towels package having pre-stacked towels with outdoor images like camouflage and hunter's orange. The field towels may be any type of cloth or synthetic material which is pre-moistened with water or one or more other solutions, such as cleaning solutions or solvents, moisturizers, disinfectants, deodorizers, fragrances, insect repellents, etc.

W.I.P.O Pat. App. No. 2013070441 from Messina James J, teaches a method of repelling an animal or insect from a surface, substrate or area comprising preparing the repellent composition containing geraniol oil and applying the repellent to a surface, substrate or area. The surface may be selected from the surface ofplants, trees, grass, water, walks, parking lots, buildings, skin, fur or pelt of an animal or human, or an article of clothing.

W.I.P.O Pat. App. No. 2005040486 from Messina James J, teaches a preparation that is to be used for defense and/or expulsion of insects as well as ticks and mites externally and prevent insects, ticks and mites are active on the skin. Insect repellents are designed to protect the skin against discomfort caused by blood sucking or biting insects. The fibers can also be colored to emphasize the visual appeal.

Therefore a need exists for an improved camouflage fabric toward overcoming these and other disadvantages of the prior art.

### BRIEF SUMMARY OF THE INVENTION

The object of the present invention to overcome the deficiencies of the prior art and to provide a hunter's repellent wipes which have camouflage properties to differentiate the hunter from the animals, so that hunters do not shoot another hunter accidently. As such, the general purpose of the present invention, which will be described subsequently in greater detail, is to provide a new and improved insect repellent wipes, which has all the advantages of the prior art and none of the disadvantages.

An object of the invention is to provide a hunter's repellent wipes or camouflage insect repellent wipes which have camouflage properties to differentiate the hunter from the animals. Further, the hunter's repellent wipes have an insect repellent properties to keep away all types of insects from the hunter.

It is another object of the present invention to provide a hunter's repellent wipe which is adapted to change the color from the existing white color of wipes which is based on the coloring agent used in the hunter's repellent wipes.

It is another object of the present invention to provide a hunter's repellent wipe which can be used by hunters, fisherman and for outdoor activity.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 illustrates a compact package having one or more camouflage insect repellent wipes, according to various embodiment of the present invention.

FIG. 2 shows camouflage insect repellent wipes having camouflage properties.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention generally provides insect repellent wipes having a camouflage properties and insects repellent properties for providing safety to the hunters of being shot by the other hunter in a hunting season and to keep away all types of insects from the hunter. Further, the a hunter's repellent wipes are camouflage insect repellent wipes.

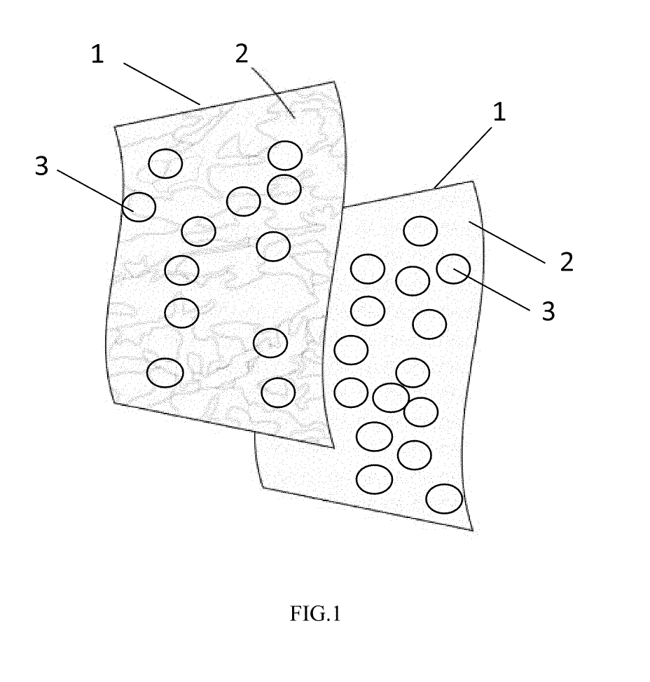

Now referring to FIG. 1, there is shown a compact camouflage insect repellent wipes package 4, wherein camouflage insect repellent wipes 1 can be easily drawn from a storage container or package 4, and the production cost can be kept low. This package 4 is provided includes an opening portion 5 from which stored wet wipes are to be drawn outward by the user. Further, the package includes a freely openable/closable lid (not shown) capable of hermetically sealing the opening portion 5. Further, the package includes at least one camouflage insect repellent wipes which is housed in a pillow-shaped package 4 having a label member 6, a openable/closable lid member (not shown) and an opening 5, thereby composing the package 4. The camouflage insect repellent wipes 1 housed in the package 4 is extracted sheet by sheet from the opening 5 to be used.

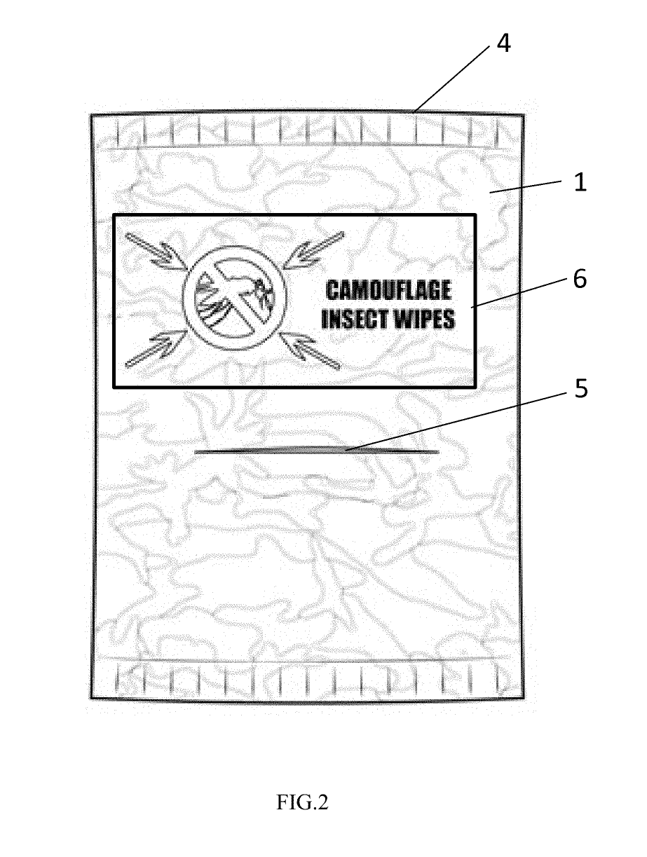

Now referring to FIG. 2, in one embodiment of the present invention, the hunter's repellent wipes or camouflage insect repellent wipes 1 includes a flexible material 2 but not limited to a woven or non-woven fabric comprising natural or synthetic fibers, or petrochemical derived polymers, flexible substrates such as wipes, pads, cloths, sponges, sponge-cloth, mats, clothing, headbands, mittens, other fibrous materials. Further, the hunter's repellent wipes include an active insect-repellent agent (not shown) which can be transferred to a surface of the people by wiping. Further, the active insect-repellent agent is chosen from insecticides, herbicides, fungicides, rodenticide, biocide, timber treatment agents, rot proofing agents, corrosion inhibitors, cosmetics, dermatological agents, polish, or combinations thereof.

Further, the hunter's repellent wipes or camouflage insect repellent wipes includes a coloring agent 3 which provides a camouflage effect to the flexible material, wherein the coloring agent is adapted to provide any type of color selected from the group consisting of yellow, orange, gold, red, blue, green shades, brown shades and purple.

In one embodiment of the present invention, the active insect-repellent agent and the coloring agents are homogeneously dispersed in the flexible material for providing insect repellent properties and camouflage properties to the camouflage insect repellent wipes. Further, the coloring agent is a is a dye, paint or finish.

Advantageously, the camouflage insect repellent wipes or tissue provides a safety feature to the people, so that hunter in the woods does not think people as a flagging deer or any other animals and does not shoot the people. Further, the hunter's repellent wipes or tissue is beneficial to the military for differentiating their own soldiers from enemy soldiers. Further, the hunter's repellent wipes or tissue provides safety to hunters and remain hidden from animal's sight.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A camouflage insect repellent wipe comprising:
a flexible material;
an active insect-repellent agent adapted to transferred to a surface by wiping;
a coloring agent which provides a camouflage effect to said flexible material;
wherein said active insect-repellent agent and said coloring agents are homogeneously dispersed in said flexible material.

2. The camouflage insect repellent wipes according to claim 1, wherein said flexiable material is chosen from a group consisting of a woven fabric, a non-woven fabric, natural fibers, synthetic fibers, petrochemical derived polymers and combinations thereof.

3. The camouflage insect repellent wipes according to claim 1, wherein said active agent is chosen from insecticides, herbicides, fungicides, rodenticides, biocides, timber treatment agents, rot proofing agents, corrosion inhibitors, cosmetics, dermatological agents, polish, pheromome attractants or combinations thereof.

4. The camouflage insect repellent wipes according to claim 1, wherein said coloring agent is adapted to provide any type of color selected from the group consisting of yellow, orange, red, blue, green, khaki, black, white and the combination thereof.

5. The camouflage insect repellent wipes according to claim 1, wherein said coloring agent is a dye, a paint, a color and the combination thereof.

6. The camouflage insect repellent wipes according to claim 1, wherein said camouflage insect repellent wipes produced by dyeing a fabric with said coloring agents.

7. The camouflage insect repellent wipes according to claim 1, wherein said camouflage insect repellent wipes keep away insects and other animals.
